(19) United States
(12) Patent Application Publication
(10) Pub. No.: US 2026/0236070 A1
(43) Pub. Date: Aug. 13, 2026

(54) INTEGRATED DUAL-SCREEN LAPTOP

(71) Applicant: BAYHAN HACISALIHOGLU, RIVER EDGE, NJ (US)

(72) Inventor: BAYHAN HACISALIHOGLU, RIVER EDGE, NJ (US)

(21) Appl. No.: 19/048,887

(22) Filed: Feb. 8, 2025

(51) Int. Cl. G06F 1/16

(52) U.S. Cl. CPC G06F 1/1681; G06F 1/1618; G06F 1/1654

(57) ABSTRACT

The invention is a laptop (10) that can be used as a tablet computer, with a standard screen, or with a wide screen. Its features include:
A body (11) that houses all components such as a keyboard, electronic hardware, processor, battery, and connection elements,
A primary screen (12) that serves as the laptop's (10) main display when the secondary screen (13) is in the folded position,
A secondary screen (13) positioned on the back of the primary screen (12), which, when unfolded, extends the screen capacity by taking place at the side of the primary screen (12),
A fixed hinge (14) located behind the secondary screen (13), allowing the secondary screen (13) to rotate from the back of the primary screen (12) to its side and connecting the secondary screen (13) to the body (11),
A movable hinge (15) that allows the primary screen (12) to move horizontally, left or right, by sliding within a slider (17), and connects the primary screen (12) to the body (11),
A vertical hinge (16) that connects the primary screen (12) and the secondary screen (13) and, when fully open, positions them at an angle of approximately 170 degrees to each other to create a curved screen effect,
A slider (17) positioned behind the primary screen (12), within which the movable hinge (15) slides to enable horizontal movement of the primary screen (12).

### TECHNICAL FIELD

The invention relates to a laptop computer featuring two screens positioned back-to-back and a specially designed hinge system that allows it to function as a tablet computer, a standard-screen laptop, or a wide-screen laptop.

### BACKGROUND

Today, the increasing demand for productivity and multitasking among computer users has popularized dual-screen usage. Especially, individuals working in business and creative industries often require more screen space to work on multiple applications or files simultaneously. Dual screens enhance productivity by enabling users to view content side by side without switching between documents. Additionally, they facilitate concurrent tasks such as video editing, coding, or data analysis, accelerating workflows.

Various methods have been developed to support dual-screen usage in current technology. In desktop setups, placing two or more monitors side by side is a common approach. However, for laptops, this becomes more complex due to considerations such as portability and ergonomics. Existing solutions typically involve attaching a second screen to the laptop. These methods include mounting the second screen above, to the right, or to the left of the main screen.

Screens added above the primary display often fall outside the user's natural line of sight, causing ergonomic issues and leading to neck and eye strain during prolonged use. Screens added to the right or left of the primary display require frequent head movements between screens, which can cause discomfort over time. Additionally, these configurations disrupt the workspace layout, negatively impacting the user experience.

For portable and compact designs, current dual-screen solutions often remain limited and impractical for laptop users. Innovative and ergonomic approaches are needed to make dual-screen laptops more user-friendly and efficient. Solutions that maintain the user's natural line of sight while offering ease of portability and comfortable use are critical to addressing these shortcomings.

One example of dual-screen implementation in personal computers is described in patent application US20040196209A1, titled “Portable Computer with Attachable Liquid Crystal Display Module”. This invention concerns an attachable liquid crystal display module for portable computers. The patent outlines a system where an external display module can be used alongside the primary display of a laptop, receiving video signals through an output port. The secondary screen module can be physically attached to the laptop via a latch mechanism and detached as needed. However, this screen is designed as a separate module rather than being fully integrated.

Another example is the invention subject to patent application number US20070188405A1, titled “Dual-Sided Video Monitor.” The invention relates to a dual-sided video monitor with a pair of screen panels mounted back-to-back. The panels can simultaneously display the same or different video signals. Each panel features an embedded viewing area capable of displaying an additional video signal. Video input signals are received via various connection protocols such as Digital Video Interface (DVI), S-Video cable, YPbPr cable, composite cable, and VGA cable. Audio output devices for each panel are provided, receiving input from an audio connection cable. These devices transmit audio in synchronization with either the screen panels or the embedded viewing area. The panels can be operated independently using individual control mechanisms that include a set of control buttons for operations like audio adjustment, image adjustment, enabling, and disabling. The monitor can have a single power source that supplies power to one or more monitor control units. Additionally, the monitor can be connected to a laptop or similar computing device.

Another example is the invention subject to patent application number US20040135738A, titled “Portable Multi-Screen Device”. The invention relates to a detachable portable multi-screen device. This portable multi-screen device includes a main body panel housing containing a first screen, a lower panel housing containing a second screen, and a connection device to attach the main body panel housing to the lower panel housing. This connection is designed so that at least one edge of the first screen can come into contact with one edge of the second screen. The panel housings can be detached and reconnected. When the panel housings are connected, the boundary between the screens is minimized, allowing the screens to appear as if functioning as a single display.

Existing patents address the use of dual screens in portable devices in various ways, typically offering limited solutions such as horizontal or vertical placement of screens or attaching one screen to another. However, these solutions often fail to fully enhance the user experience. For instance, placing screens side by side can lead to inefficiencies in the field of view, as users may not be able to view both sides equally. Additionally, restricting the placement to either horizontal or vertical orientation lacks flexibility and adaptability. Therefore, there is a growing need for a more flexible solution that better meets user requirements, providing more efficient transition and harmony between screens.

In conclusion, the presence of disadvantages in the existing technology and the insufficiency of current solutions have necessitated advancements in the relevant technical field to address the need for an integrated dual-screen laptop.

### BRIEF DESCRIPTION OF THE INVENTION

The present invention relates to a laptop computer that meets the aforementioned requirements, eliminates all disadvantages, and offers additional advantages. It features two back-to-back screens connected to each other and integrated into the body via a specialized hinge system, enabling the device to function as a tablet, a standard-screen laptop, and a wide-screen laptop.

Based on the prior art, the objective of the invention is to provide a system that enables more efficient and user-friendly use of dual screens in portable devices.

The objective of the invention is to enable more efficient and adaptive use of screens by presenting a novel approach that overcomes the limitations of placing the second screen on the right or left, or other arrangements with restricted flexibility found in the prior art. This approach allows for seamless transitions between screens and creates a broader range of usability.

Another objective of the invention is to provide users with a wider visual area and a more comfortable usage experience by ensuring the seamless integration of the screens.

Another objective of the invention is to make transitioning between the device's screens easier and more user-friendly through the use of a specialized hinge structure.

Another objective of the invention is to create an efficient working environment by minimizing the boundaries between screens, thereby offering a larger viewing area.

Another objective of the invention is to allow flexible horizontal and vertical adjustment of the screens, enabling users to position the screen more comfortably according to different usage scenarios and ensuring adaptability to their needs.

Another objective of the invention is to provide a more suitable solution for different device and application uses by allowing flexible horizontal and vertical adjustment of the screens.

Another objective of the invention is to create a more compact structure by positioning the screens closer together and in a unified manner.

Another objective of the invention is to increase the portability of the device and provide users with more practical experience by creating a more compact structure.

Another objective of the invention is to position the two screens at an approximately 170 degrees angle when opened, using a vertical hinge that connects them. This configuration allows the screens to function like a curved display.

Another objective of the invention is to ensure that the screens sit perfectly back-to-back when fully unfolded, facilitated by a movable hinge located at the back of the second screen, which fits into a corresponding slot.

The structural and characteristic features of the invention, along with all its advantages, will be more clearly understood through the detailed description provided below, referencing the accompanying figures. Therefore, the evaluation should be made with consideration of these figures and the detailed explanations.

### THE BRIEF DESCRIPTION OF THE FIGURES

To fully understand the structure of the current invention and its advantages with the inclusion of additional elements, it should be evaluated alongside the figures described below.

FIG. 1: Schematic general view of the second screen when the screens are not lifted.

FIG. 2: Schematic general view of the first screen when the screens are lifted.

FIG. 3: Schematic detailed view of the fixed hinge.

FIG. 4: Schematic detailed view of the movable hinge.

FIG. 5: Schematic general view of the unfolding mechanism of the second screen.

FIG. 6: Schematic front general view of the unfolding mechanism of both the second and first screens.

FIG. 7: Schematic rear general view of the unfolding mechanism of both the second and first screens.

FIG. 8: Schematic front general view of the second and first screens when fully unfolded.

FIG. 9: Schematic rear general view of the second and first screens when fully unfolded.

FIG. 10: Schematic top-down general view of the second and first screens when fully unfolded.

### REFERENCE NUMBERS

10. Portable Device (i.e. Laptop/Tablet)
11. Body
12. First screen
13. Second screen
14. Fixed hinge
15. Movable hinge
16. Vertical hinge
17. Slider
18. Hinge slot

### DETAILED DESCRIPTION OF THE INVENTION

In this detailed description, the invention, which involves two screens positioned back-to-back and connected by a specialized hinge system, is described in the context of a portable device (10) that can be used as a tablet, a standard-screen laptop, or a wide-screen laptop. This explanation serves solely as an example to aid in the understanding of the subject matter and does not impose any restrictive effects.

The portable device (10) described in the invention is a versatile device that can be used both as a tablet and as a laptop with an additional screen to offer various functionalities. The mentioned laptop (10) enables multi-functional use by ensuring the integrated operation of the first screen (12) and the second screen (13), allowing them to work together seamlessly based on the user's needs.

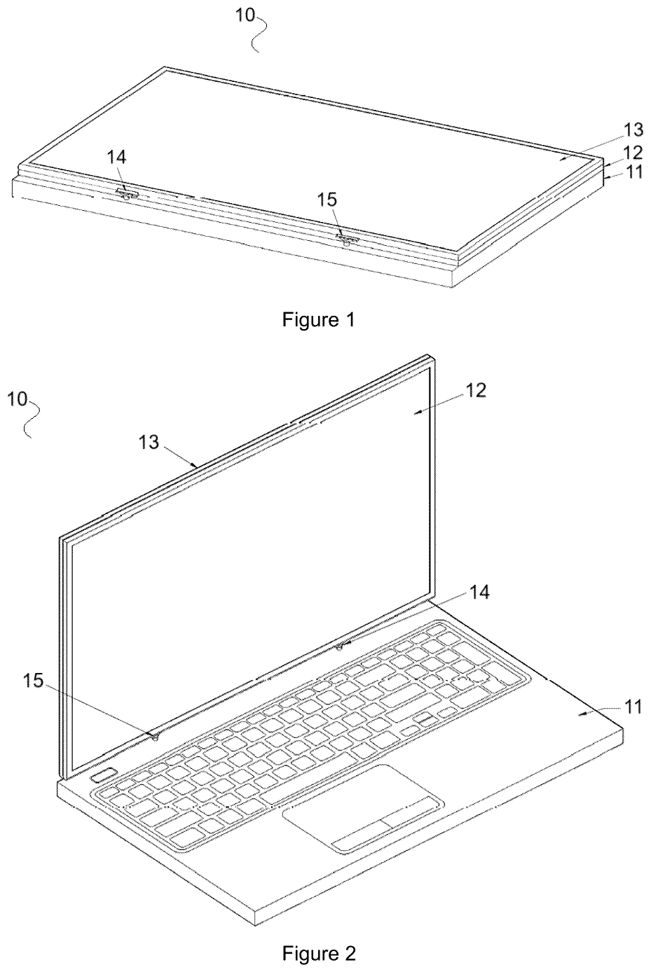

The laptop (10) shown in FIG. 1 contains a body (11) that houses all the components such as the keyboard, electronic hardware, processor, battery, and connection elements. The body (11) serves as the central unit ensuring that these components work together. Additionally, there is a button on the body (11) to allow the laptop (10) to be used as a tablet when the second screen (13) is folded. This button helps activate the mechanism needed to turn on and off the second screen (13). The second screen (13) is a screen placed next to the first screen (12), increasing the laptop's (10) screen capacity. The second screen (13) is connected to the body (11) via a fixed hinge (14) and to the first screen (12) via a vertical hinge (16). The mentioned fixed hinge (15) allows the second screen (13) to move by pushing the first screen (12) to the side, positioning the second screen next to it.

The first screen (12), shown in FIG. 2, serves as the main display of the laptop (10) when the second screen (13) is in folded position and typically provides the primary view for the user. The first screen (12) is connected to the body (11) via a movable hinge (15), which allows its position to be adjusted. Additionally, the first screen (12) is linked to the second screen (13) through a vertical hinge (16).

When only the first screen (12) is being used, the second screen (13) remains in folded position on the back side.

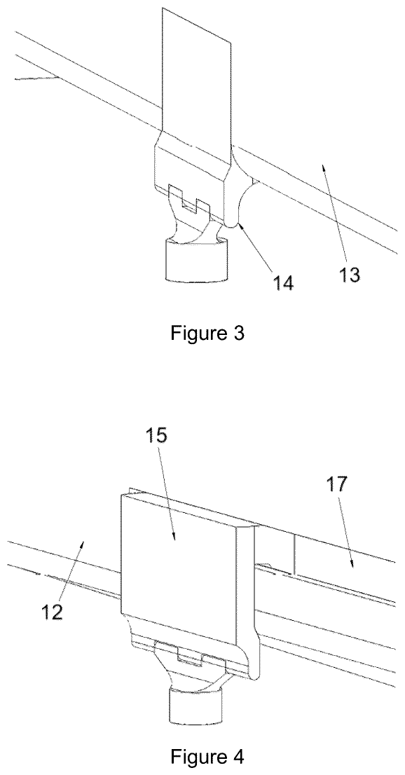

The fixed hinge (14), shown in FIG. 3, is located at the back of the second screen (13) and serves as the core component of the mechanism enabling the movement of the second screen (13). The fixed hinge (14) allows the second screen (13) to rotate in place and move from the back of the first screen (12) to its side. Additionally, the fixed hinge (14) facilitates the passage of electrical and data cables. These cables pass through the fixed hinge (14), connecting first to the second screen (13) and then to the first screen (12), enabling data transmission between both screens.

The movable hinge (15), shown in FIG. 4, is connected to a slider (17) located at the back of the first screen (12). The movable hinge (15) moves within the slider (17) to adjust the position of the first screen (12). It enables the first screen (12) to slide sideways toward the edge of the body (11). This ensures that, when the second screen (13) is unfolded, both screens together align the body centrally. The rail (17) works in conjunction with the movable hinge (15), allowing the first screen (12) to move horizontally to the right or left along the axis.

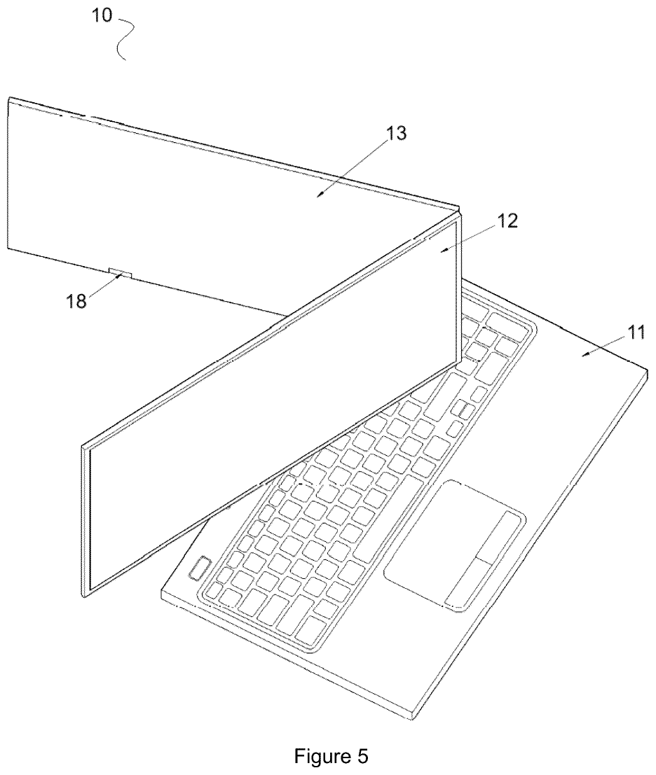

The vertical hinge (16), which connects the first screen (12) and the second screen (13), ensures that when both screens are fully unfolded, they are fixed at approximately 170 degrees angle relative to each other. This angle allows the first screen (12) and the second screen (13) to function as a curved display, enhancing the user experience. As shown in FIG. 5, a hinge slot (18) is positioned on the back of the second screen (13) to enable it to fit snugly against the back of the first screen (12) when folded. The movable hinge (15), located on the back of the first screen (12) and connected to the slider (17), fits into this hinge slot (18), allowing the second screen (13) to be folded seamlessly against the back of the first screen (12) without leaving any gaps.

When the laptop (10) is turned off and the screens are folded, the second screen (13) is on top, the first screen (12) is beneath it, and the body (11) is at the bottom. In this fully folded state, the laptop (10) can be used as a tablet computer due to the second screen (13) being positioned on top. To enable this functionality, the second screen (13) can be turned on using the button located on the body (11). In this folded position, the first screen (12) and the second screen (13) align back-to-back, and the hinge slot (18) eliminates any gaps between them.

If the laptop (10) is to be used with a standard screen, the first screen (12) is lifted upward from the body (11) to open. Once opened, the laptop (10) can be used with the standard screen width.

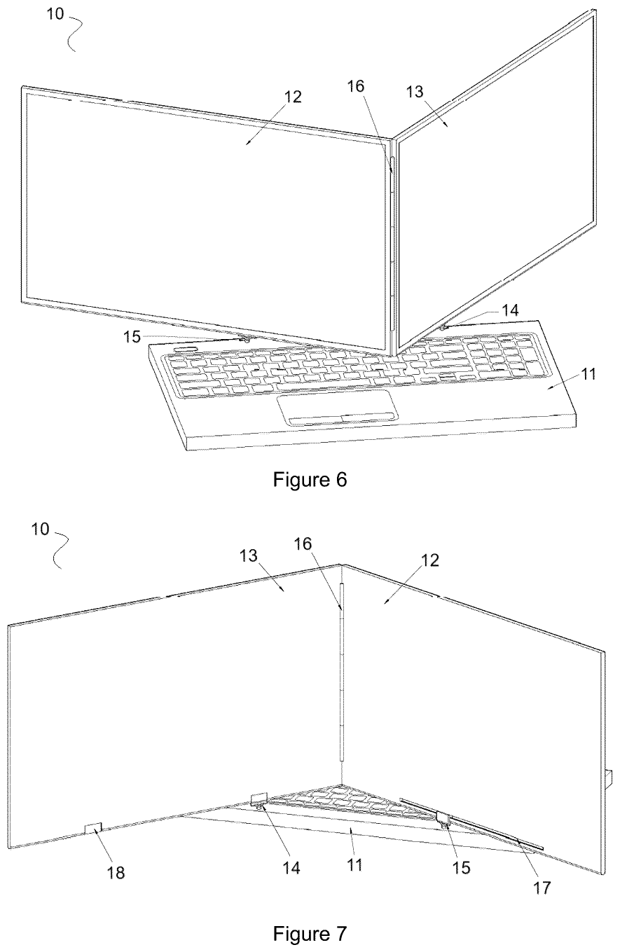

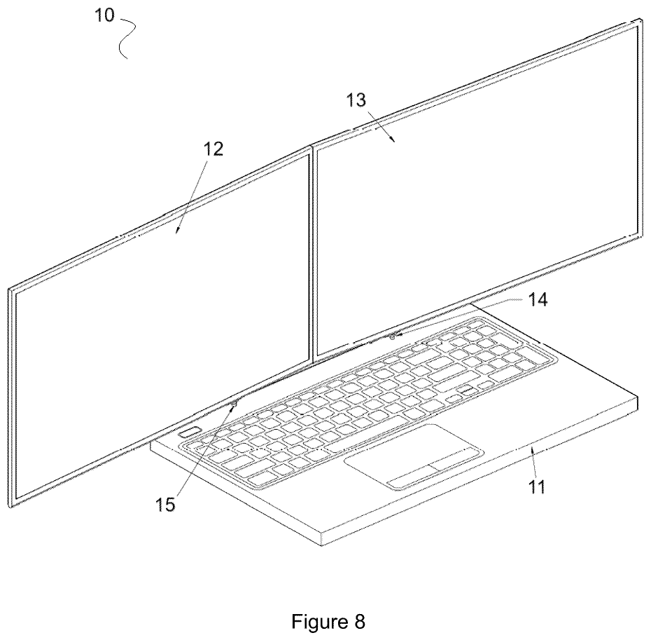

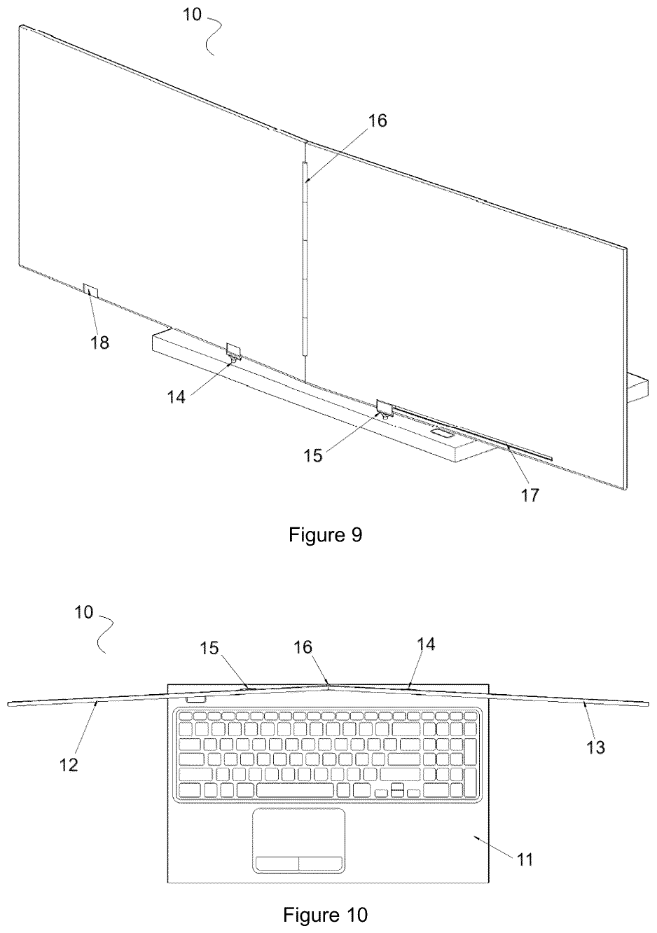

For the wide-screen usage of the laptop (10), the first screen (12) is lifted first. Subsequently, the second screen (13), located at the rear, is pushed forward and unfolds outward from behind the first screen (12) as shown in FIG. 6. The first screen (12) slides sideways within the slider (17) via the moveable hinge (15), as depicted in FIG. 7, while the second screen (13) rotates in place via the fixed hinge (14) and moves to the side of the first screen (12), as illustrated in FIG. 8. During this process, the vertical hinge (16), which connects the first screen (12) and the second screen (13), extends backward to open. The movement of the first screen (12) by the movable hinge (15) toward the side of the body (11) ensures that when the second screen (13) is fully unfolded, both screens together align the body centrally. As shown in FIG. 9, the vertical hinge (16) positions the second screen (13) at an angle of approximately 170 degrees relative to the first screen (12) when fully unfolded. This angle between the first screen (12) and the second screen (13), as depicted in FIG. 10, creates a curved display effect during wide-screen usage, enhancing the user experience and improving the field of view.

The described laptop (10) enables the flexible use of the first screen (12) and the second screen (13) according to the user's needs, both in folded and unfolded states. By leveraging the advantages of the mobility of the first screen (12) and the second screen (13), the laptop (10) provides users with a wider display area, enhancing their overall experience.

1. A laptop (10) that can be used as a tablet computer, with a standard screen, and with a wide screen, characterized by;
a body (11) containing all the components such as the keyboard, electronic hardware, processor, battery, and connection elements,
a primary screen (12) that serves as the main screen of the laptop (10) when the second screen (13) is in the folded position,
a second screen (13) positioned on the back of the primary screen (12) that unfolds next to the first screen (12) to increase the laptop's (10) screen capacity,
a fixed hinge (14) positioned on the back of the second screen (13), which allows the second screen (13) to rotate from the back of the first screen (12) and connect the second screen (13) to the body (11),
a movable hinge (15) that slides within a slider (17), allowing the primary screen (12) to move left and right and connect the primary screen (12) to the body (11),
a vertical hinge (16) that connects the first screen (12) and second screen (13) at approximately 170 degrees angle when fully unfolded,
a slider (17) positioned behind the primary screen (12) that enables horizontal movement of the primary screen (12) within the movable hinge (15).
A laptop (10) according to claim 1, characterized by: A button positioned on the body (11) to allow the laptop (10) to be used as a tablet when the second screen (13) is in the folded position.
A laptop (10) according to claim 1, characterized by: An electrical and data cable passing through the fixed hinge (14), connecting first to the second screen (13) and then to the first screen (12).
A laptop (10) according to claim 1, characterized by: A hinge cavity (18) positioned on the back of the second screen (13), where the movable hinge (15) fits, ensuring that when the second screen (13) is folded, it fits perfectly against the back of the first screen (12) without any gap.
A laptop (10) according to claim 1, characterized by: The alignment of the second screen (13) alongside the first screen (12), when the first screen (12) is laterally shifted by the movable hinge (15), ensuring that both screens are centered relative to the body (11).
